(19) United States
(12) Patent Application Publication
(10) Pub. No.: US 2019/0226642 A1
(43) Pub. Date: Jul. 25, 2019

(54) FLUID CONTAINER WITH INTEGRATED FLUID-CONTROL DEVICE

(71) Applicant: JDSE Limited, Shrewsbury (GB)

(72) Inventor: Tom Knight, Shrewsbury (GB)

(73) Assignee: JDSE Limited, Shrewsbury (GB)

(21) Appl. No.: 16/341,417

(22) PCT Filed: Oct. 9, 2017
(86) PCT No.: PCT/GB2017/053054

§ 371 Date: Apr. 11, 2019

(30) Foreign Application Priority Data
Oct. 12, 2016 (GB) 1617338.7

(51) Int. Cl. F17C 13/04

(52) U.S. Cl. CPC F17C 13/04; F17C 2201/0109; F17C 2209/234; F17C 2209/2172; F17C 2209/221; F17C 2203/0639; F17C 2203/066; F17C 2205/0323; F17C 2209/2181; F17C 2203/0617

(57) ABSTRACT

A fluid container (10) for fluid containment. The internal surface of the container body (12) defines a fluid-containment chamber (14), which has at least one fluid inlet and/or outlet port (18). Associated with at least one fluid inlet and/or outlet port (18), there is a fluid-flow control device, having a control body (16) integrally formed with the container body (12) as one piece.

The present invention relates to a fluid container, in particular but not necessarily exclusively to a cylinder for containing high-purity, preferably compressed, gas or liquid for industrial, scientific or medical use.

Specialized fluid containers with fluid-control devices are commonly utilised in industry and medicine for the storage, transport and controlled use of compressed, high purity and/or hazardous fluids. Industrial applications for such include chemical feedstock, refrigerants and gas supplies for welding. Safe fluid containers are also of critical importance in research and development in the chemical industry, engineering, and the physical and chemical sciences more broadly. In medicine, fluid containers are used to store and apply gases for anaesthesia and respiratory treatment.

There are a few challenges to be overcome with respect to adequate containment of fluid, especially highly pressurised and/or active gas. In the case of highly pressurised gas samples, especially flammable and/or explosive gas samples, failure of the container may have catastrophic consequences, so secure containment is essential. Elimination of potential points of weakness is therefore a priority in improving gas cylinder design.

In the case of active fluids, such as fluids which are corrosive, unstable, and/or reactive, there can be an issue of contamination or corrosion of the joints of the fluid container, particularly at or adjacent to valves or other devices controlling the flow of fluid to and from the fluid container. This is a particular problem for screw-threaded joints, which typically use sealing compounds or tapes to stop leakage along the screw-thread pathway to make it fluid-tight. In the present art, valves are typically connected to the container body by connector elements with screw-thread connections, resulting in two screw-threaded connections proximal to the valves.

Joints are invariably weaker than the surrounding material, and therefore the common alternative of welding fluid control device bodies to outlets of fluid containers typically introduces a new point of weakness in the container. Weakness at the valve/container body interface is a common cause of compressed gas cylinder failure in transit, as significant shear force is typically experienced by the valve body if the container is accidentally displaced.

It is an object of the present invention to provide a more durable, safer design of fluid container, which optionally may be constructed in a modular fashion.

According to a first aspect of the invention, there is provided a fluid container for fluid containment, the fluid container comprising: a container body including an internal surface defining a fluid-containment chamber which has at least one fluid inlet and/or outlet port and which is devoid of a thread; and one or more fluid flow control devices associated with the at least one fluid inlet and/or outlet port, the or each fluid-flow control device having a control body integrally formed with the container body as one-piece.

Preferably, the control body forms at least part of an end of the container body, and it may close the fluid-containment chamber.

By providing a fluid container body comprising one or more integral fluid-flow control devices the number of joints required proximal to the device or devices is decreased. In particular an intermediated screw-threaded connection between the flow-control devices and the fluid container body is no longer required. This beneficially allows for the production of a fluid container with a longer functional lifetime, especially in the storage of active fluids, due to the improved device resilience achieved by the elimination of what would typically be a screw-threaded connection. The likelihood of failure of the flow-control device, which may typically be a valve for example, over the lifetime of the fluid container is also beneficially reduced. Furthermore, fluid escape pathways via the screw-threaded connections are eliminated.

The fluid container may comprise a plurality of container body portions so as to permit access to the internal surfaces of the fluid container prior to assembly, allowing the manufacturer to improve the smoothing and treating of the inner surfaces, for example, using electropolishing and/or applying a passive coating. Whilst doing so, it is still possible to maintain a smooth, contiguous surface at or adjacent to any joints, thereby limiting or eliminating any likely sorption effects that would otherwise result. This beneficially allows for the manufacture of a fluid container which is less likely to become contaminated due to said sorption effects.

A central container body portion or portions intermediate to the end caps or end cap container body portions may be used to provide the majority of the internal volume of the fluid container. It will be apparent that identical end caps could be used for a plurality of different cylinders or containers, with different central container body portions being utilised in order to alter the dimensions of the fluid container as a whole. This modularity advantageously reduces an overall cost to manufacture a plurality of containers of different internal volumes.

An engagement interface of each container body portion may preferably be formed as a flat perimeter surface, mutually co-operable with a corresponding engagement interface on another container body portion, the engagement interfaces being suitable for welding, preferably electron beam, laser, fusion or orbital welding and/or bonding.

By providing clean, flat surfaces on the container body portions which are mutually compatible, it is possible to ensure that the components can be cleanly welded and/or bonded to one another, ensuring that the joints between component parts are robustly held together without leaks, whilst also maintaining a contiguous abutment or overlap between the inner surfaces of the container.

The two end cap container body portions and the intermediate container body portions advantageously may be complementarily shaped so as to form a smooth, contiguous inner surface for the fluid container.

Preferably, one end of the container may be closed by spin forming. This advantageously allows for the treatment of the inner surfaces before closure of a unitary fluid container with integrated fluid control device body, and allows for the formation of a fluid container with a substantively flat, concave or convex bottom or closure independent of the method used to form the main container body.

In a preferred embodiment, the container body portion or portions may be devoid of screw-threaded engagement portions, and/or the inner surface of the fluid chamber may be devoid of a screw-thread, and/or at least one inlet and/or outlet port is devoid of a screw-thread. Providing a fluid container which is completely welded together, and lacking screw-threads at the inlets and/or outlets by utilising an integral valve body or other suitable integral fluid-flow control means, as well as being devoid of a screw-thread in the fluid-containment chamber, particularly at an interface with a gas or liquid to be held therein, reduces or prevents the potential for fluid escape pathways through screw-threads and/or failure at or in the vicinity thereof.

Beneficially, the inner surface of the fluid-containment chamber may be smoothed and/or passivated to have a surface roughness less than 0.40 microns, and most preferably less than 0.25 microns.

The fluid container may be provided in the form of a kit of parts, or may be provided as a fully-assembled unit. The kit of parts preferably may include the interior components of the fluid control device, a unitary fluid container or pre-welded fluid container. Alternatively, the kit of parts may comprise a multiplicity of fluid container body components, allowing welding to form a custom modular fluid container.

According to a second aspect of the invention, there is provided a method of manufacture of a fluid container in accordance with the first aspect of the invention, the method comprising the steps of: a) forming an open container body with a control body integrally formed therewith, the container body at least in part defining a fluid-containment chamber; and b) closing the container body and fluid-containment chamber.

Preferably, in a step intermediate to steps a) and b), an inner surface of the fluid-containment chamber is smoothed and/or passivated.

The invention will now be more particularly described, by way of example only, with reference to the accompanying drawings, in which:

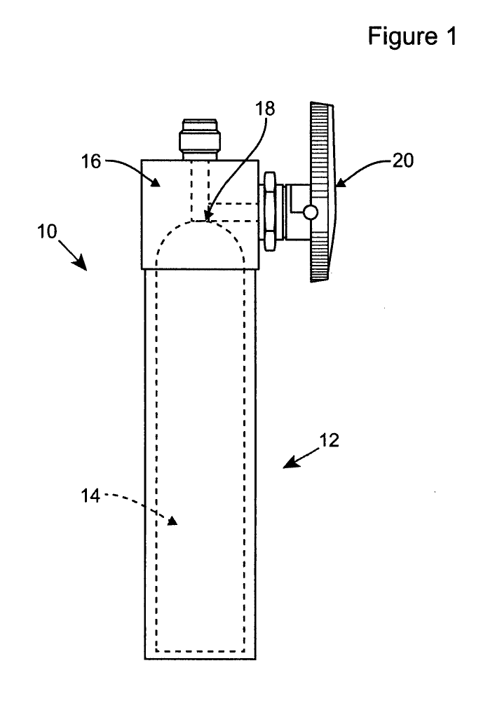

FIG. 1 shows a plan view of a first embodiment of a fluid container, in accordance with the first aspect of the invention; and

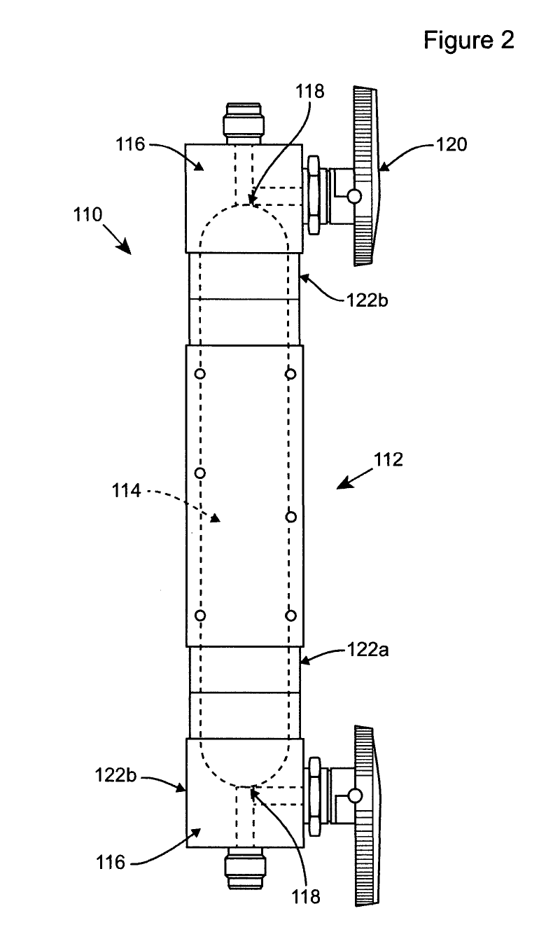

FIG. 2 shows a plan view of a second embodiment of a fluid container, in accordance with the first aspect of the invention.

Referring firstly to FIG. 1, there is shown a fluid container, indicated globally at 10, for the containment of fluid. Examples of such fluids might extend to high temperature or pressure acids or alkalis, explosive gases such as hydrogen or methane, or highly toxic and corrosive gases such as chlorine or hydrogen sulphide. Fluid containers therefore need to be able to withstand the rigours of transporting a wide-variety of such fluids.

The fluid container 10 has a container body 12 formed preferably as an elongate cylindrical tube from a suitably unreactive material, such as stainless steel, glass, or possibly some unreactive plastics and has a, preferably cylindrical or substantively cylindrical inner surface of uniform diameter along its longitudinal extent or at least a majority of its longitudinal extent, indicated by the dashed lines. The inner surface of the container body 12 thereby defines a substantively cylindrical volume 14 therein.

One or more fluid control device bodies 16 are integrally formed as one-piece with the container body 12. This provides a more robust container than typically known fluid containers.

The fluid control device body 16 most preferably may be a valve body as shown in FIG. 1, but may also extend to other fluid control devices; for instance, it may preferably be a pump housing, in particular when the fluid is compressed water or liquid chemical feedstock. Without a valve body which projects from the container body 12 in a cantilevered manner via a fluid port, as commonly found in the technical field, there is less likelihood of damage or breakage during storage, transit or use.

The fluid control valve may be operable by a lever or tap 20, which is attached or mounted to the fluid control device body 16. The tap 20 is here shown as a plastic moulded tap with, for example, a 90 degree turn, but other embodiments would be obvious to the person skilled in the art, for instance a metal stopcock or a plastics moulded tap with a 360 degree turn.

Furthermore, by integrally forming the fluid control valve body 16 with the container body 12, and therefore entirely as a unitary block of material, a connection, which would typically be a welded joint, is avoided at a fluid port 18 interconnecting the fluid control valve body 16 and the container body 12. Consequently, this results in a more robust arrangement allowing the option for significantly higher fluid pressures to be accommodated within the interior volume without or with less risk of fracture or leakage. Being able to accommodate pressures from 0 bar or 0 kPA to 1000 bar or 100 MPa and higher may be of particular use in the emerging technical field of hydrogen storage and use.

The fluid control valve body 16 may preferably be formed at one end of the container body 12. The fluid control valve body 16 may advantageously be located on an uppermost or furthestmost end of the container body 12. In this case, the fluid control valve body 16 may preferably be integrated into a substantively convex end portion of the container body.

Alternatively, the fluid control valve body may be preferably integrated into a cuboid block, allowing the integral container body 12 to be aligned flush to a substantially planar surface. Preferably, the valve exit or discharge port is coaxial or substantially coaxial with a longitudinal axis of the container body 12, and the valve tap 20 is formed so as to be perpendicular to the longitudinal axis of the container body 12. However, as may be appreciated, the discharge port may be offset from the longitudinal axis of the container body, as necessity dictates.

Furthermore, an internal diameter or bore associated with or within the fluid control valve body 16 may be suitable for holding a check valve, globe valve, ball valve or needle valve. For clarity, these are not shown in the drawings.

The fluid container valve body 16 may preferably be finished after integral formation, to impart additional functionality; for instance, it may preferably be adapted for connection of the valve body and the inlet/outlet thereof to a gas regulator, or pipeline, by threading, socketing or flanging of a portion or portions of the valve body.

The fluid container 10, including the integral valve body 16, may be manufactured by die casting, deep drawing, rotary piercing, hot metal form spinning, and/or forging. Other manufacturing processes may also be considered. It may be preferable to manufacture the fluid container in a single process, or otherwise to treat the inner surface of an unsealed and/or unclosed fluid container before sealing and/or closing it using a form spinning method. The integral valve body 16 may be formed during this closure process, or alternatively form spinning may be used to create a concave, convex or substantively flat closure.

Referring now to FIG. 2 of the drawings, there is shown a second embodiment of a fluid container. Parts which are identical or similar to those of the first embodiment utilise the same reference numerals with 100 added, and further detailed description is omitted for brevity.

The fluid container 110 has a container body 112 which may preferably comprise a plurality of container body portions 122 interengaged to form the assembled container body 112. Although three container body portions 122 are provided, being a central container body portion 122a and first and second end cap container body portions 122b, a single container body, two container body portions, or more than three container body portions may be utilised to provide a modular device.

Each end cap container body portion 122b may include the fluid control valve body 116 integrally formed therewith as one-piece. There is provided a direct or substantially direct interface port 118 between the body of the valve 116 at each end of the fluid chamber 114, the required volume of the fluid chamber 114 being optimised relative to the length of the fluid container 110. In other words, an end-to-end length of the fluid container 110 including the fluid control valve body 116 can be shortened or extended whilst maintaining the same interior fluid chamber length. This can allow flow through the cylinder, rather than merely acting as a reservoir.

One end cap container body portion 122b is engaged at either end of the central container body portion 122a. The combined inner surfaces of the central container body portion and end cap container body portions, as indicated by the dashed lines in FIG. 2, are complementarily shaped so as to form a smooth, contiguous inner surface for the fluid container 110 as a whole.

The inner surface defines a fluid chamber 114 of the fluid container 110, the volume of which is defined by the sum of the volumes of the container body portions 122. As with the first embodiment described above, this volume is preferably devoid of threads, such as screw-threaded connections, and may be both smooth and passivated in certain instances; this limits sorption onto the interior surface, whilst also reducing surface roughness which might disturb or interfere with fluid flow within the fluid chamber 114.

To secure the container body portions 122 so as to form the fluid container 110 in its assembled state, the container body portions 122 may preferably be welded together along the respective circumferential perimeters of the individual central or end cap container body portions 122a, 122b.

The advantage of the illustrated fluid container 110 as described over unitarily-formed sample cylinders is that, prior to assembly, the internal surfaces of the central and end cap container body portions 122a, 122b can be better mechanically smoothed, using physical machining tools, and subsequently passivated to limit the effects of sorption. This passivation would primarily be achieved using electropolishing, which involves the insertion of the container body portions 122 into an electrolyte to electrochemically smooth the internal surfaces of the container body portions, the container body portion 122 acting as an anode in the electrochemical cell. Ideally, the internal surfaces are smoothed so as to have a surface roughness of less than 0.40 microns, and preferably less than 0.25 microns, in order to minimise sorption effects.

Additionally, or alternatively, any required passivation could be achieved by the application of a physically and/or chemically inert passive coating to the internal surfaces, such as a silicone-based coating. One example of such a coating might be a silicone-based coating such as SilcoNert 2000® available from SilcoTek, 225 PennTech Drive, Bellefonte, Pa. 16823, USA; other similarly inert coatings are available. Other means of passivation of a metal surface will be apparent to the skilled reader, and the above-mentioned techniques do not represent an exhaustive list.

As above, although the fluid control device bodies 116, in this case being valve bodies, are integrally incorporated at both ends of the fluid container 110, one or more one-way, bidirectional or multi-directional valve body or bodies allowing inlet and outlet control of liquid or gas could be provided at one end only. In this case, the or each valve body, preferably with two valves associated therewith, may again be formed as one-piece with the container body portion 114a, 114b. As such, only a single end cap container body portion 114b may be required, with the central body portion 114a having a base portion and therefore being closed at one end or vice versa.

The present method of manufacturing a fluid container also does not necessarily have to be used to passivate the internal surfaces of the container body portions. Any action which might need to be performed to the internal surface of the container prior to assembly would feasibly benefit from such a method of construction. For example, it may be desirable to etch the internal surface, or chemically activate or deactivate the surface for catalytic uses.

Threads, such as screw-threads may be provided on the container 10, 110, at positions spaced from the fluid control devices, such as inlet/outlet valves, if required. However, the surface which is in contact with a gas or liquid to be received within the fluid-containment chamber 14, 114 defined by the or each container body 12, 112 and/or associated integral valve body 16, 116 should preferably be threadless and as such any transition between parts should preferably be contiguous and consequently smooth. The flow control device is formed integrally with the container body in order to control a flow of fluid into and out of the fluid containment chamber.

It is therefore possible to provide a fluid container for a fluid having at least one integrally formed fluid-flow control device thereon. This prevents or reduces the likelihood of the fluid flow control device being damaged where it interfaces with the container body. The fluid container with integrated flow-control device, such as a valve, may be one-piece or a plurality of parts. In the latter case, a part of the fluid container includes the integral control body forming part of the flow-control device and to which control parts are typically subsequently added or incorporated. Furthermore, it is possible to provide a fluid container with a closable fluid-containment chamber therein which is devoid of threads.

The container body parts may be welded and/or bonded together in such a manner so as to remove the need for screw-threaded joints therebetween, which can lead to routes for fluid egress, weakening the joints of the fluid container and increasing the risk of fluid contamination. Although orbital welding may be utilised, any other suitable permanent engagement means may be considered, such as electron beam welding, fusion welding and/or laser beam welding, and/or bonding as described above.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention herein described and defined.

1. A fluid container for fluid containment, the fluid container comprising: a container body including an internal surface defining a fluid-containment chamber which has at least one fluid inlet and/or outlet port and which is devoid of a thread; and one or more fluid-flow control devices associated with the at least one fluid inlet and/or outlet port, the or each fluid-flow control device having a control body integrally formed with the container body as one-piece.

2. The fluid container as claimed in claim 1, wherein the control body forms at least part of an end of the container body.

3. The fluid container as claimed in claim 1, wherein the control body closes the fluid-containment chamber.

4. The fluid container as claimed in claim 1, wherein the container body comprises two or more mutually engagable container body portions, and at least one of the container body portions is provided as an end cap container body portion, the control body being integrally formed as one-piece with the end cap container body portion.

5. The fluid container as claimed in claim 4, wherein two said end cap container body portions are included, each having a said control body integrally formed therewith.

6. The fluid container as claimed in claim 4, wherein at least one of the said two or more mutually engagable container body portions is an intermediate container body portion interposed between two said end cap container body portions, enabling modular construction of the container body.

7. The fluid container as claimed in claim 6, wherein the two end cap container body portions and the intermediate container body portion are complementarily shaped so as to form a smooth, contiguous inner surface for the fluid container.

8. The fluid container as claimed in claim 1, wherein the container body is closed at one end by spin forming.

9. The fluid container as claimed in claim 1, wherein the inner surface of the fluid-containment chamber is devoid of a screw-thread.

10. The fluid container as claimed in claim 1, wherein at least one fluid inlet and/or outlet port is devoid of a screw-thread.

11. The fluid container as claimed in claim 1, wherein the inner surface of the fluid-containment chamber is smoothed and/or passivated to have a surface roughness less than 0.40 microns.

12. The fluid container as claimed in claim 11, wherein the inner surface of the fluid-containment chamber is smoothed and/or passivated to have a surface roughness less than 0.25 microns.

13. The fluid container as claimed in claim 1, provided in the form of a kit of parts.

14. The method of manufacture of a fluid container as claimed in claim 1, the method comprising the steps of: a) forming an open container body with a control body integrally formed therewith, the container body at least in part defining a fluid-containment chamber; and b) closing the container body and fluid-containment chamber.

15. The method of manufacture as claimed in claim 14, further comprising a step intermediate to steps a) and b), wherein an inner surface of the fluid-containment chamber is smoothed and/or passivated.

16. The fluid container as claimed in claim 1, wherein the fluid-flow control device comprises a valve tap formed so as to be perpendicular to a longitudinal axis of the container body.

17. The fluid container as claimed in claim 16, wherein the at least one fluid inlet and/or outlet port is coaxial or substantially coaxial with the longitudinal axis of the container body.

18. The fluid container as claimed in claim 1, wherein the control body is a cuboid block allowing the container body to be aligned flush to a planar or substantially planar surface thereof.
